(19) United States
(12) Patent Application Publication
(10) Pub. No.: US 2014/0182421 A1
(43) Pub. Date: Jul. 3, 2014

(54) SOCKET SEPARABLE SPANNER

(71) Applicant: HUNG-WEN CHANG, Taichung City (TW)

(72) Inventor: HUNG-WEN CHANG, Taichung City (TW)

(21) Appl. No.: 13/802,809

(22) Filed: Mar. 14, 2013

(30) Foreign Application Priority Data
Dec. 28, 2012 (TW) 101151155

(51) Int. Cl. B25B 23/00; B25B 13/06

(52) U.S. Cl. CPC B25B 23/0035; B25B 13/06
USPC 81/124.3; 81/124.7

(57) ABSTRACT

The present invention is composed of a main body, a rotary ring, a fixing member, and a spring plate. The main body includes a sleeve projecting from a top end of a driving hole and including a guide aperture extending through the driving hole. The rotary ring has a bore rotatably coupled to the sleeve to be rotatable between first and second positions. The bore has an inside surface forming a retention chamber having first and second recessed curved faces. The fixing member is movably received in the guide aperture. The spring plate is arranged between the fixing member and the retention chamber and has one side fixed to the sleeve and a curved section formed between two sides thereof. In the first position, the first recessed curved face positions the curved section. In the second position, the second recessed curved face positions the curved section.

### TECHNICAL FIELD OF THE INVENTION

The present invention generally relates to a socket separable spanner, and more particularly to a spanner having a rotary ring that provides a two-stepped control means and that eliminates the concern of undesired separation of socket with the socket is mounted thereto.

### DESCRIPTION OF THE PRIOR ART

Taiwan Utility Model No. M293816 discloses a device, in which a ratchet wheel has a driving hole in which sockets of different sizes can be interchangeably mounted. The driving hole comprises a ring groove. The socket comprises a retention slot mating the ring groove. The ring groove receives and fixes therein a clamp element so that the retention slot is engageable with or disengageable from the clamp element. Practically, the retention slot needs to form a chamfer in one side. This may lead to unexpected separation of the socket from the driving hole when a user is swinging the spanner. Apparently, such a known device is dangerous more or less for a spanner is a hand tool of substantial weight. The socket, once flying away or falling down, may hurt people standing around. The known device certainly does not meet the requirement for operation safety.

In view of the problem of unexpected detachment of socket, it is an issue to be addressed in the industry by providing a spanner of high safety.

The present invention aims to provide a solution that overcomes the above discussed problems and shortcomings.

### SUMMARY OF THE INVENTION

The present invention provides a socket separable spanner, which comprise:

a main body, which comprises a driving hole for receiving insertion of a socket therein and comprises a sleeve projecting from a top of the driving hole, the sleeve comprising a guide aperture radially extending through the driving hole;

a rotary ring, which comprises a bore that is rotatably coupled to the sleeve to be rotatable between a first position and a second position, the bore having an inside surface that is recessed to from a retention chamber, the retention chamber comprising radially deepened first recessed curved face and second recessed curved face;

a fixing member, which is movably received in the guide aperture; and

an elastic member, which is arranged between the fixing member and the retention chamber and has one side fixed to an outer circumferential surface of the sleeve and comprises a curved section between two sides thereof, whereby when the rotary ring is rotated to the first position, the first recessed curved face positions the curved section therein so that the fixing member is received between the guide aperture and the spring plate and when the rotary ring is rotated to a second position, the second recessed curved face positions the curved section therein so that the second recessed curved face forces, via compressing the curved section of the spring plate, the fixing member to have a portion of the fixing member extending into the driving hole to engage the socket.

In summary, the present invention provides at least two features:

(1) The rotary ring cooperates, via the spring plate, with the first recessed curved face and the second recessed curved face of the retention chamber to provide a function of simplified two-stepped control.

(2) The spring plate and the retention chamber effectively keep the fixing member and the retention groove in an engagement condition to prevent the socket from slipping off the driving hole in an axial direction so as to improve the issue of insufficiency of operation safety and is thus a high level invention having significant effectiveness.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the present invention.

FIG. 2 is a perspective view of the present invention in an assembled form.

FIGS. 3 and 4 are longitudinal sectional views showing an operation of mounting and dismounting a socket according to the present invention.

FIG. 5 is a lateral sectional view showing a rotary ring of the present invention in a first position;

FIG. 6 is a lateral sectional view showing the rotary ring of the present invention in a second position.

FIG. 7 is a longitudinal sectional view showing the rotary ring of the present invention in the second position.

FIG. 8 is a longitudinal sectional view showing a second embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

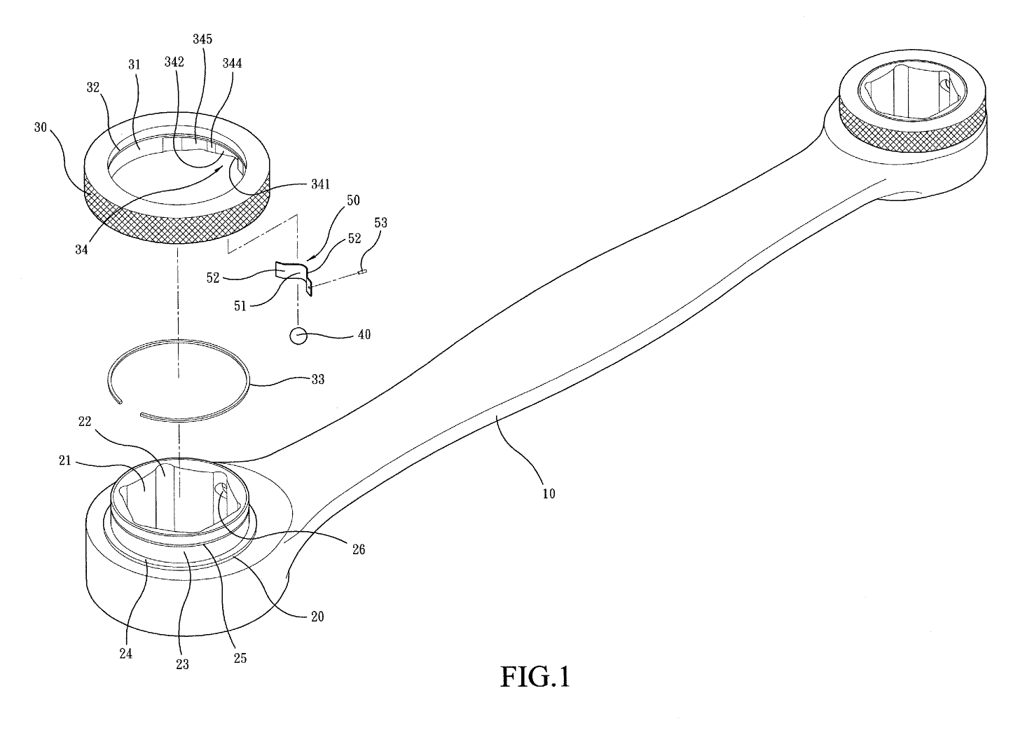

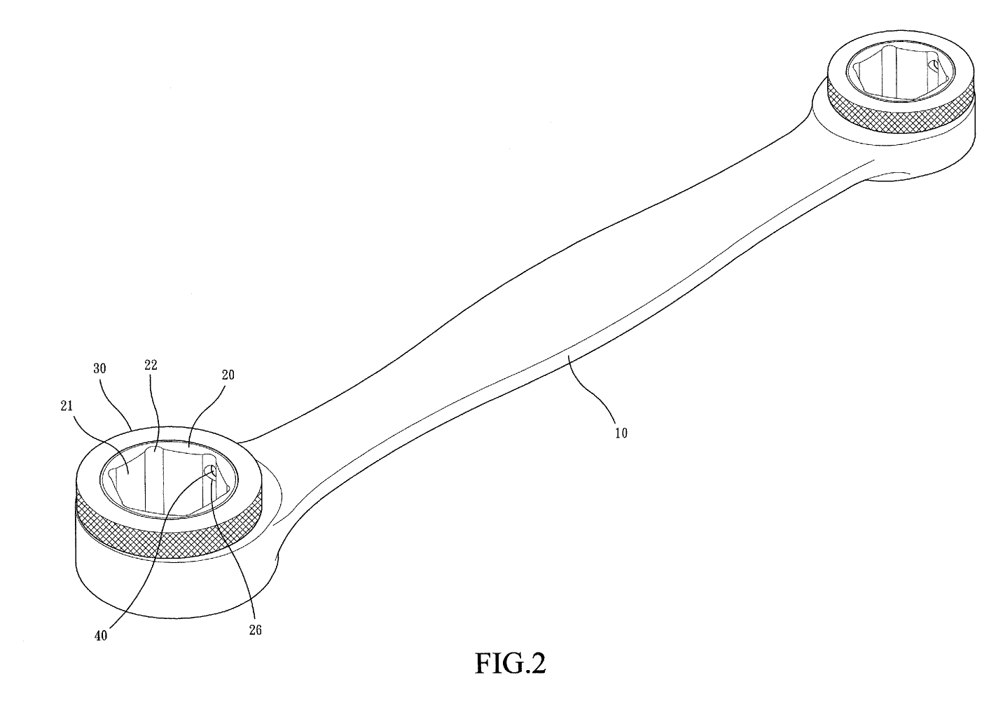

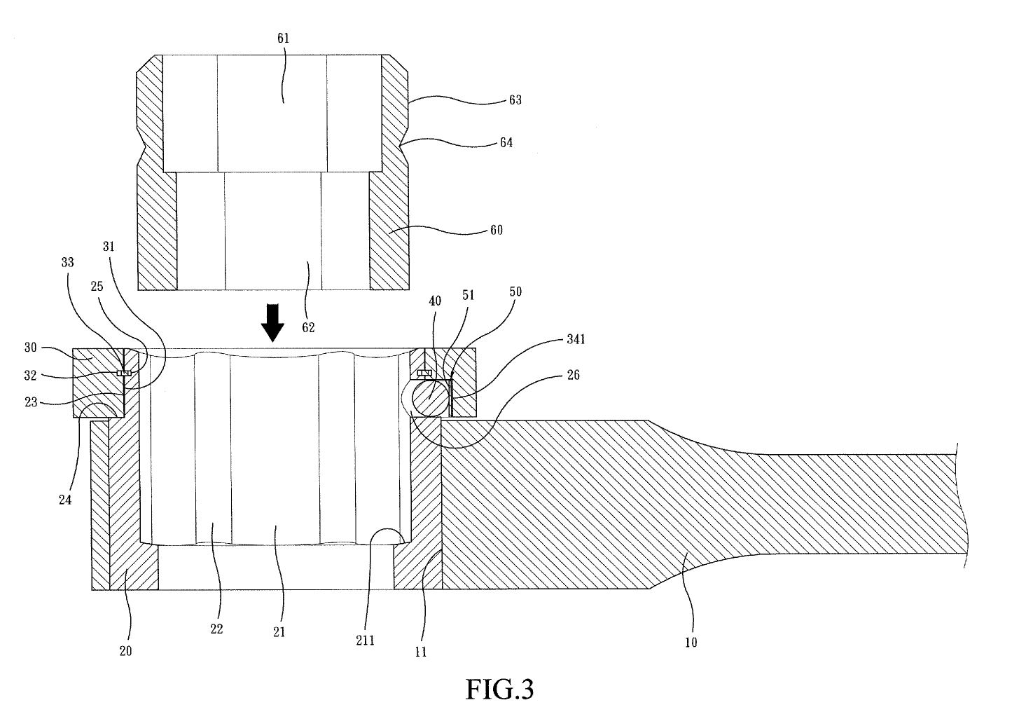

Referring to FIGS. 1-5, the present invention provides a spanner, which comprises the following components:

A main body 10 comprises a receiving hole 11 extending completely therethrough in a vertical direction.

An interfacing member 20 is coaxially received in the receiving hole 11. The interfacing member can be integrally combined with the main body 10 or can alternatively be arranged in the receiving hole 11 in a way similar to a ratchet (which is known in a conventional ratchet spanner so that further details will be omitted herein). The interfacing member 20 forms centrally a regular hexagonal driving hole 21 extending therethrough. The driving hole 21 receives a socket 60 to fit therein so that the main body 10 can drive the socket 60 to rotate for loosening or tightening a fastener element (such as a bolt or a nut). According to the present invention, a positioning section 211 having a reduced inside diameter is formed in a bottom of the driving hole 21. Further, a corner slot 22 is formed in each corner where two sides of the hexagon intersect each other. The interfacing member 20 has an end forming a sleeve 23 that is of symmetry and projects beyond the receiving hole 11 and has a reduced outside diameter, whereby a radially and outward expanded shoulder 24 is formed in a root of the sleeve 23. The sleeve 23 has an outer circumferential surface in which a first circumferential groove 25 is formed and a guide aperture 26 is provided below the first circumferential groove 25 and radially extends through one of the corner slots 22 so that the guide aperture 26 is in communication with outside and inside of the driving hole 21. The guide aperture 26 has a lip 261 formed at an inner end thereof adjacent to the driving hole 21 and being of a reduced inside diameter.

A rotary ring 30 comprises a bore 31 completely extending therethrough in the vertical direction and rotatably coupled to the sleeve 23. The rotary ring 30 has a bottom end that is constrained by the shoulder 24. The bore 31 has an inside surface that is recessed to form a second circumferential groove 32. The second circumferential groove 32 mates the first circumferential groove 25 to receive a retention ring 33 installed therein so that the rotary ring 30 is rotatable, with the sleeve 23 as a center, between a first position and a second position without detachment in an axial direction. The inside surface of the bore 31 is further recessed to form a retention chamber 34 corresponding to the guide aperture 26. The retention chamber 34 comprises a first recessed curved face 341 that is deepened in the radial direction. The first recessed curved face 341 has two sides that are jointed, in a symmetrical manner, to first tapering faces 342 that gradually reduce the depth. The first recessed curved face 341 and the two first tapering face 342, in combination, show a V-shape when observed in a top plan view. One of the first tapering faces 342 has an opposite end jointed to a cavity 343, and the other one of the first tapering face 342 has an opposite end jointed to a second recessed curved face 344, whereby the second recessed curved face 344 has a depth in the radial direction that is smaller than the radial depth of the first recessed curved face 341. The second recessed curved face 344 has an opposite end that is jointed to a second tapering face 345 having a gradually reduced depth. The second tapering face 345 has a slope greater than the first tapering face 342.

A fixing member 40 is in the form of a sphere movably received in the guide aperture 26, whereby a portion of the sphere is allowed to move in and out of the driving hole 21 but is constrained by the lip 261 from falling into the guide aperture and an opposite portion of the sphere is prevented from retracting into he guide aperture 26 no matter how the fixing member 40 moves.

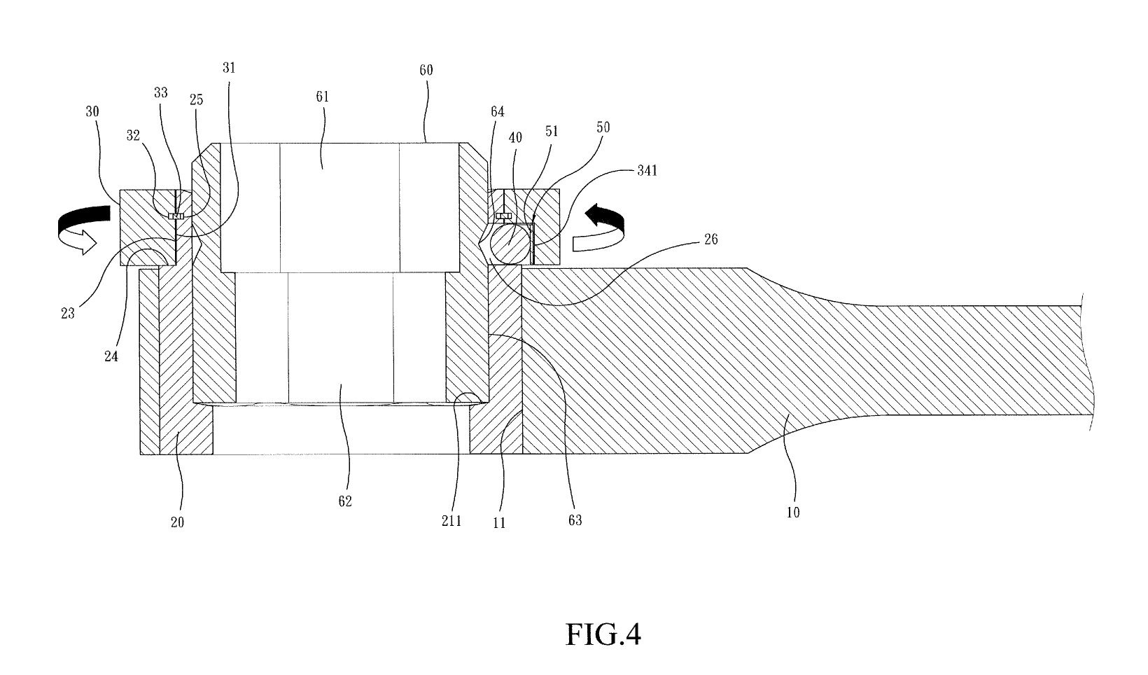

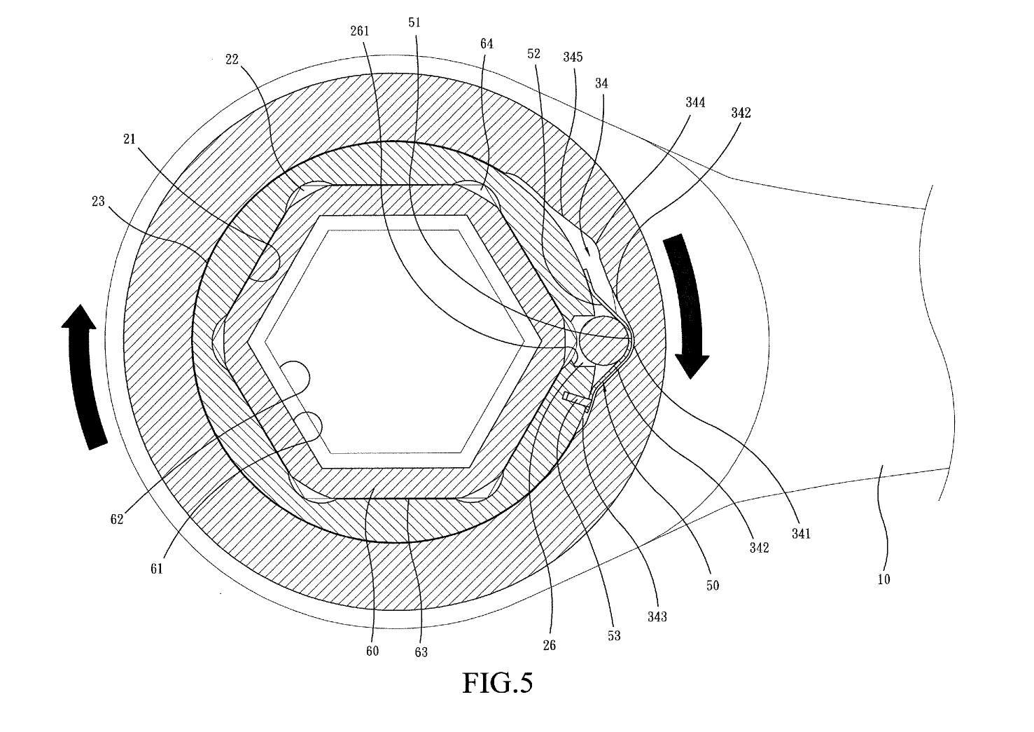

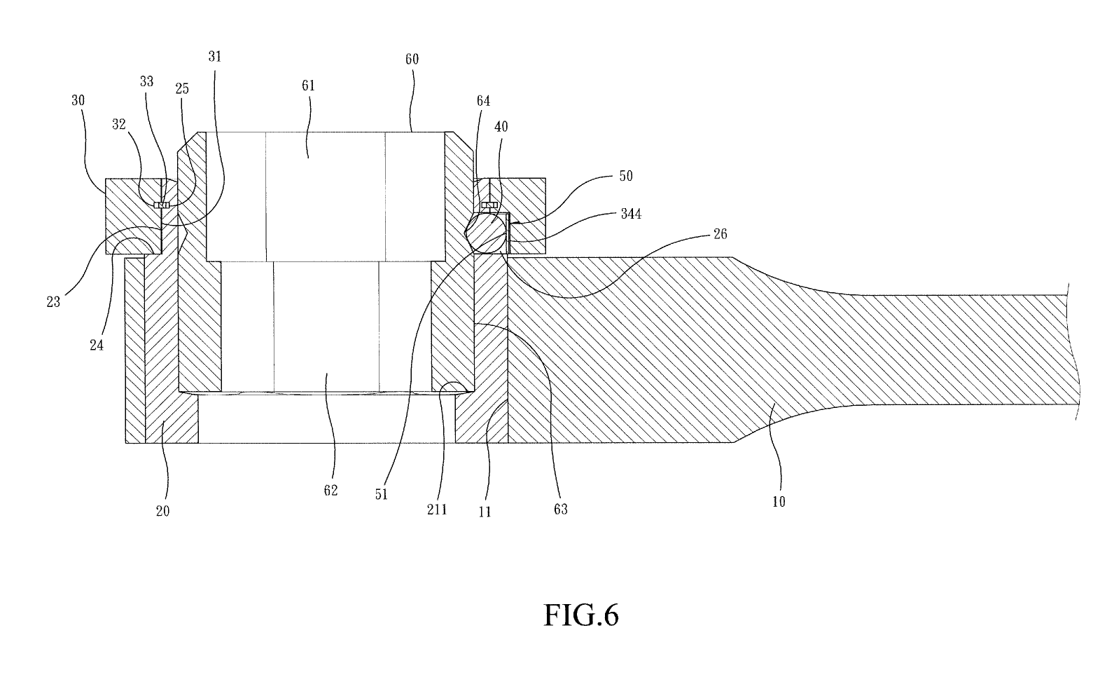

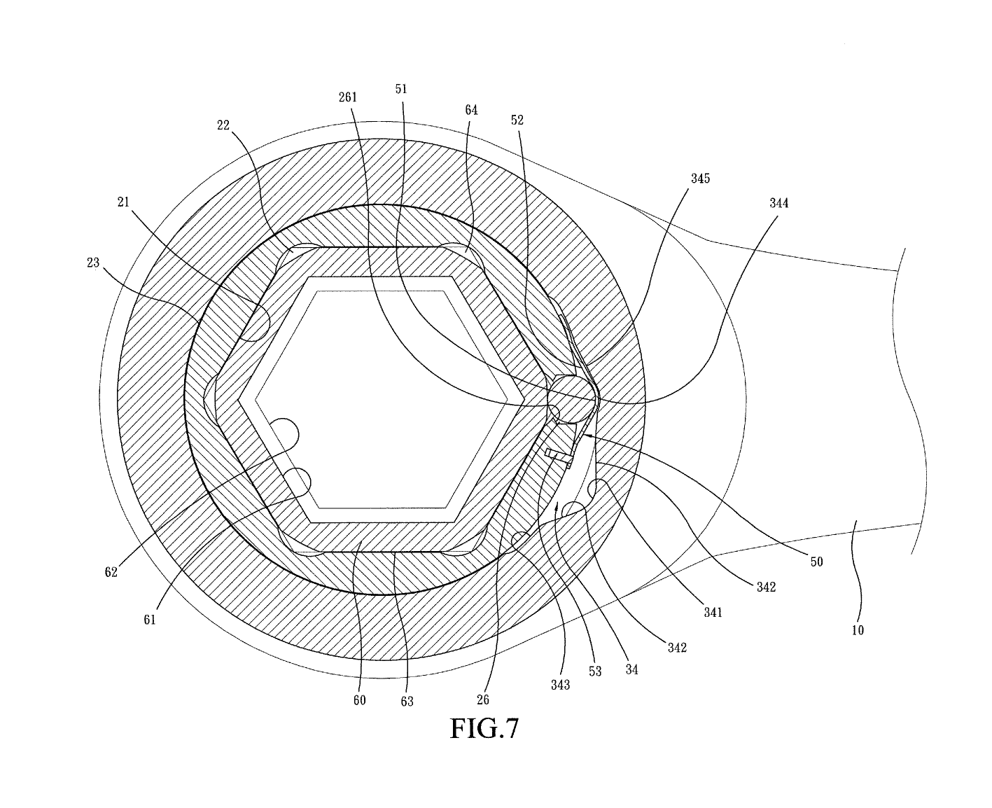

An elastic member, which in a spring plate 50 in the instant embodiment, is mounted to an outer circumferential surface of the sleeve 23 and located between the fixing member 40 and the retention chamber 34 to position the rotary ring 30 at the first position that corresponds to the first recessed curved face 341 and a second position that corresponds to the second recessed curved face 344 during the rotation of the rotary ring. The spring plate 50 is of a V-shaped when observed in a top plan view and comprises a curved section 51 corresponding to the first recessed curved face 341 or the second recessed curved face 344. The curved section 51 has two sides from which inclination sections 52 extend. One of the inclination sections 52 has an outer end that is fixed by a connection section 53 to the outer circumferential surface of the sleeve 23. The other one of the inclination sections 52 has an outer end that forms a free end close to or positioned flat on the outer circumferential surface of the sleeve 23 so that the curved section 51 and the two inclination sections 52 cover the outer side of the guide aperture 26, as shown in FIGS. 4 and 5. When the curved section 51 is positioned in the first recessed curved face 341, the two inclination sections 52 oppose the two first tapering faces 342 and the connection section 53 is located in the cavity 343. Since the first recessed curved face 341 has a greater radial depth, the spring plate 50 resumes an original shape so that the fixing member 40 is completely located between the guide aperture 26 and the two inclination sections 52. As shown in FIGS. 6 and 7, when the curved section 51 is positioned in the second recessed curved face 344, the two inclination sections 52 oppose the adjacent one of the first tapering faces 342 and the second tapering face 345. Since the second recessed curved face 344 has a radial depth that is smaller than that of the first recessed curved face 341, the second recessed curved face 344 compresses the curved section 51 of the spring plate 50 to make the outer end of the other one of the inclination sections 52 expanding, increasing the included angle between the two inclination sections 52, thereby forcing the fixing member 40 to have a portion thereof entering the driving hole 21.

A socket 60 is a cylindrical body having opposite top and bottom ends. The top end is centrally recessed to form a first fitting hole 61 that is capable of driving a fastener element. The bottom end is centrally recessed to form a second fitting hole 62. The second fitting hole 62 has a diameter less than that of the first fitting hole 61 for driving a fastener element of a smaller size. The socket 60 has an outer circumference that forms a driving face 63 mating the driving hole 21. When the bottom end of the socket 60 is inserted into the driving hole 21 and positioned on the positioning section 211, the driving hole 21 drives the socket 60 to rotate. The outer circumference of the socket 60 is radially recessed to form a retention groove 64 corresponding to the fixing member 40. When the rotary ring 30 is rotated to the first position, the fixing member 40 is separated from the retention groove 64 so as to enable replacement of a socket 60 having different sizes of first fitting hole 61 and second fitting hole 62. However, when the rotary ring 30 is rotated to the second position, the fixing member 40 engages the retention groove 64 so as to prevent the socket 60 from get loosened in the axial direction, enabling a user to use the socket 60 to loosen or tighten a fastener element.

It can be seen from the above described structure that when the main body 10 is jointed to a socket 60, the rotary ring 30 cooperates, via the spring plate 50, with the first recessed curved face 341 and the second recessed curved face 344 of the retention chamber 34 to provide a function of perceivable two-stepped control, of which the operation is easy. Importantly, when the rotary ring 30 is rotated to the second position, the spring plate 50 and the retention chamber 34 effectively keep the fixing member 40 and the retention groove 64 in an engagement condition to prevent the socket 60 from slipping off the driving hole 21 in an axial direction. Practical tests show that when a direct knocking operation is taken by using the socket 60 attached to the main body 10, the socket 60 is still not detached from the driving hole 21. Apparently, the present invention can effectively improve the risk of easy detachment of the conventional device and can enhance the operation safety.

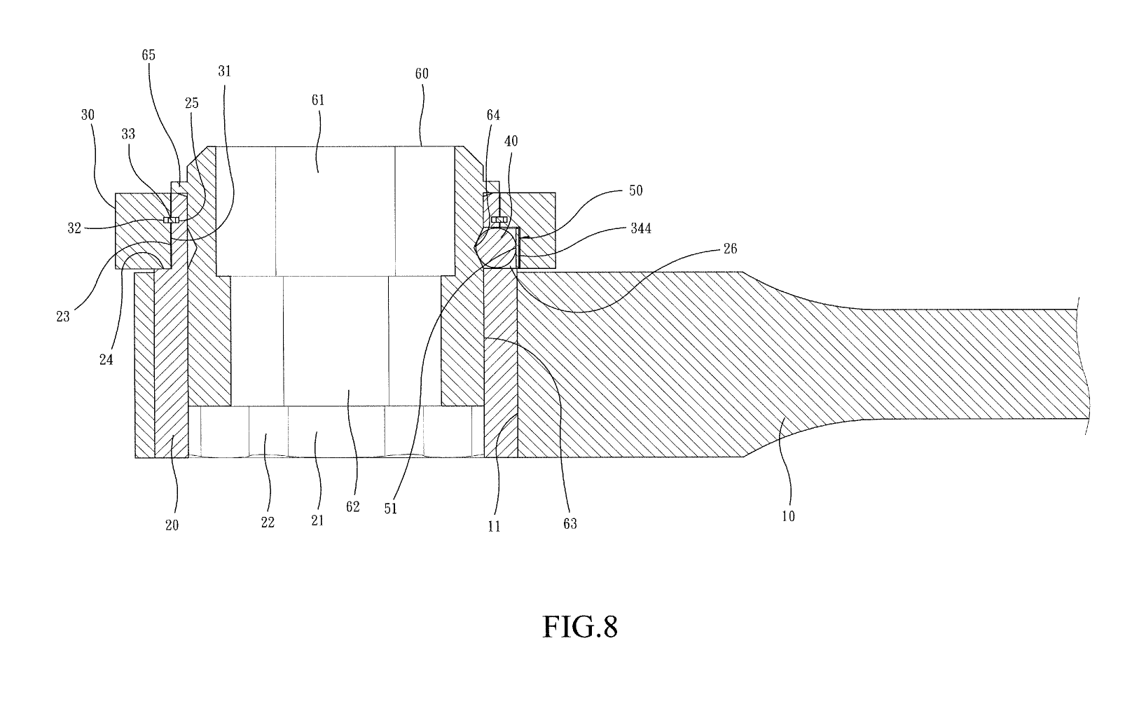

Referring to FIG. 8, this demonstrates that the positioning section 211 is not a necessary part of the driving hole 21 according to the present invention and can be replaced by a circumferential support section 65 that radially projects from a top portion of the socket 60. When the socket 60 is inserted into the driving hole 21, the circumferential support section 65 is positionable on the top of the sleeve 23 to achieve initial positioning of the socket 60, enabling the rotary ring 30 to control the retaining engagement established between the socket 60 and the driving hole 21.

It is known from the above description that the overall structural arrangement of the present invention is novel, where rotation of the rotary ring between the first and second positions is sufficient to control the establishment of retaining engagement between the socket and the driving hole. Importantly, when the socket is retained in the driving hole for operation, there is no risk of undesired separation so as to enhance operation safety.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A socket separable spanner, comprising:
a main body, which comprises a driving hole for receiving insertion of a socket therein and comprises a sleeve projecting from a top of the driving hole, the sleeve comprising a guide aperture radially extending through the driving hole;
a rotary ring, which comprises a bore that is rotatably coupled to the sleeve to be rotatable between a first position and a second position, the bore having an inside surface that is recessed to from a retention chamber, the retention chamber comprising radially deepened first recessed curved face and second recessed curved face;
a fixing member, which is movably received in the guide aperture; and
an elastic member, which is arranged between the fixing member and the retention chamber and has one side fixed to an outer circumferential surface of the sleeve and comprises a curved section between two sides thereof, whereby when the rotary ring is rotated to the first position, the first recessed curved face positions the curved section therein so that the fixing member is received between the guide aperture and the spring plate and when the rotary ring is rotated to a second position, the second recessed curved face positions the curved section therein so that the second recessed curved face forces, via compressing the curved section of the spring plate, the fixing member to have a portion of the fixing member extending into the driving hole to engage the socket.

2. The socket separable spanner according to claim 1, wherein the retention chamber comprises a first tapering face connected to each of the two sides of the first recessed curved face and having a gradually reduced depth, an opposite end of one of the first tapering faces being connected to the second recessed curved face, the second recessed curved face having an opposite end connected to second tapering face having a gradually reduced depth, the second tapering face having a slope greater than a slope of the first tapering face, the spring plate comprising an inclined section extending from each of two sides of the curved section, one of the inclination sections having an outer end that is fixed by a connection section to an outer circumference of the sleeve, another one of the inclination sections having an outer end forming a free end close to or positioned flat on the outer circumference of the sleeve, the curved section and the two inclination section covering outside the guide aperture, whereby when the curved section is positioned in the first recessed curved face, the two inclination sections oppose the two first tapering face to allow the fixing member to be received between the guide aperture and the two inclination sections and when the curved section is positioned in the second recessed curved face, the two inclination sections oppose the adjacent one of the first tapering faces and the second tapering face to allow the second recessed curved face compress the curved section of the spring plate, making the outer end of the other one of the inclination sections expanding and increasing an included angle between the two inclination sections to force a portion of the fixing member to extend into the driving hole.

3. The socket separable spanner according to claim 1, wherein the socket has an outer circumference that forms a driving face mating the driving hole so that when the socket is inserted into the driving hole and positioned, the driving hole drives the socket to rotate, the outer circumference of the socket being radially recessed to form a retention groove corresponding to the fixing member, whereby when the rotary ring is rotated to the first position, the fixing member is separated from the retention groove and when the rotary ring is rotated to the second position, the fixing member engages the retention groove.

4. The socket separable spanner according to claim 3, wherein the socket is a cylindrical body having opposite top and bottom ends, the top end being centrally recessed to form a first fitting hole that is adapted to drive a fastener element, the bottom end being centrally recessed to form a second fitting hole that has a diameter less than that of the first fitting hole and is adapted to drive a fastener element of a smaller size.

5. The socket separable spanner according to claim 3, wherein the driving hole has a bottom on which a diameter reduced positioning section is formed, the positioning section positioning the socket when the bottom of the socket is inserted into the driving hole so as to have the retention groove corresponding to the fixing member.

6. The socket separable spanner according to claim 3, wherein the socket has a top portion from which a circumferential support section radially projects, the circumferential support section positioning the socket when the bottom of the socket is inserted into the driving hole so as to have the retention groove corresponding to the fixing member.

7. The socket separable spanner according to claim 1, wherein the main body comprises a receiving hole extending completely therethrough in a vertical direction, the receiving hole coaxially receiving an interfacing member therein, the interfacing member having an end forming a sleeve that is of symmetry and projects beyond the receiving hole and has a reduced outside diameter, whereby a radially and outward expanded shoulder is formed in a root of the sleeve, the shoulder constraining the bottom of the rotary ring.

8. The socket separable spanner according to claim 1, wherein the driving hole is of a regular polygon and comprises a corner slot formed in each corner where two sides of the polygon intersect each other, the guide aperture being arranged to extend through one of the corner slots to communicate with the driving hole.

9. The socket separable spanner according to claim 1, wherein the sleeve has an outer circumferential surface in which a first circumferential groove is formed, the first circumferential groove being located above the guide aperture, the rotary ring comprising a second circumferential groove formed in an inside surface of the bore, a retention ring being arranged between the first circumferential groove and the second circumferential groove.

10. The socket separable spanner according to claim 1, wherein the guide aperture has a lip formed at an inner end thereof adjacent to the driving hole and being of a reduced inside diameter, the fixing member being constrained by the lip from falling into the guide aperture.

11. The socket separable spanner according to claim 2, wherein the socket has an outer circumference that forms a driving face mating the driving hole so that when the socket is inserted into the driving hole and positioned, the driving hole drives the socket to rotate, the outer circumference of the socket being radially recessed to form a retention groove corresponding to the fixing member, whereby when the rotary ring is rotated to the first position, the fixing member is separated from the retention groove and when the rotary ring is rotated to the second position, the fixing member engages the retention groove.

12. The socket separable spanner according to claim 11, wherein the socket is a cylindrical body having opposite top and bottom ends, the top end being centrally recessed to form a first fitting hole that is adapted to drive a fastener element, the bottom end being centrally recessed to form a second fitting hole that has a diameter less than that of the first fitting hole and is adapted to drive a fastener element of a smaller size.

13. The socket separable spanner according to claim 11, wherein the driving hole has a bottom on which a diameter reduced positioning section is formed, the positioning section positioning the socket when the bottom of the socket is inserted into the driving hole so as to have the retention groove corresponding to the fixing member.

14. The socket separable spanner according to claim 11, wherein the socket has a top portion from which a circumferential support section radially projects, the circumferential support section positioning the socket when the bottom of the socket is inserted into the driving hole so as to have the retention groove corresponding to the fixing member.

15. The socket separable spanner according to claim 2, wherein the main body comprises a receiving hole extending completely therethrough in a vertical direction, the receiving hole coaxially receiving an interfacing member therein, the interfacing member having an end forming a sleeve that is of symmetry and projects beyond the receiving hole and has a reduced outside diameter, whereby a radially and outward expanded shoulder is formed in a root of the sleeve, the shoulder constraining the bottom of the rotary ring.

16. The socket separable spanner according to claim 2, wherein the driving hole is of a regular polygon and comprises a corner slot formed in each corner where two sides of the polygon intersect each other, the guide aperture being arranged to extend through one of the corner slots to communicate with the driving hole.

17. The socket separable spanner according to claim 2, wherein the sleeve has an outer circumferential surface in which a first circumferential groove is formed, the first circumferential groove being located above the guide aperture, the rotary ring comprising a second circumferential groove formed in an inside surface of the bore, a retention ring being arranged between the first circumferential groove and the second circumferential groove.

18. The socket separable spanner according to claim 2, wherein the guide aperture has a lip formed at an inner end thereof adjacent to the driving hole and being of a reduced inside diameter, the fixing member being constrained by the lip from falling into the guide aperture.
